(19) United States
(12) Patent Application Publication
(10) Pub. No.: US 2006/0286306 A1
(43) Pub. Date: Dec. 21, 2006

(54) Method of producing advanced low dielectric constant film by UV light emission

(75) Inventors: Naoki Ohara, Tokyo (JP); Atsuki Fukazawa, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 11/155,841

(22) Filed: Jun. 17, 2005

(51) Int. Cl. B05D 3/00; C08J 7/18; B29C 71/04

(52) U.S. Cl. 427/532; 427/489

(57) ABSTRACT

A method of treating a low-dielectric constant film includes: depositing a low-dielectric constant film on a substrate, which is structured by Si—C bond and has a first leakage current; and emitting ultraviolet (UV) light to the film until the film has a second leakage current which is ½ or less of the first leakage current.

### BACKGROUND OF THE INVENTION

The present invention relates to a semiconductor film processing technology used in the process for manufacturing semiconductor element forming circuits and more specifically to a method to improve semiconductor films.

Improvements in the performance of semiconductor devices, such as increase in processing speed and reduction of power consumption, require use of low-dielectric constant interlayer insulation films in the devices. However, the methods to achieve higher integration and more minute structure, which have been developed to reflect the recent trends for semiconductor devices with higher integrations and more minute structures, increase the generation frequency of leakage current, which causes dielectric breakdown of low-dielectric constant interlayer insulation films. This results in lower yields of semiconductor devices as well as device deterioration and malfunction.

Several methods have been proposed for improving the properties of thin films deposited on semiconductor substrates by emitting ultraviolet (UV) light to the films. U.S. Pat. No. 6,756,085 discloses improvements in film modulus and hardness, while U.S. Pat. No. 6,284,050 discloses improvements in film hardness, adhesion and stability. As specified in the above U.S. patents, the main purpose of emitting UV light to these films is to harden the films and improve their mechanical strength and modulus.

### SUMMARY OF THE INVENTION

One embodiment of the present invention provides a method to improve device performance, wherein the method, when used in semiconductor manufacturing, prevents device damages due to diffusion of metal elements or significantly improves device resistance to leakage current by means of emitting UV light to a low-dielectric constant barrier film (low-K barrier film) that has been formed to serve as a stop in the etching step. In this case, improvement of the film's mechanical strength is virtually absent (improvement is minimal, if any, and no improvement occurs in some embodiments). In another embodiment of the present invention, device resistance to leakage current is improved significantly by depositing a low-dielectric constant film and then emitting UV light to the film. This treatment may also reduce the film's relative dielectric constant and improve its mechanical strength. In yet another embodiment of the present invention, different low-dielectric constant films are stacked on top of one another to provide a laminated film structure for use in semiconductor manufacturing. This laminated film structure mainly comprises low-dielectric constant interlayer films (low-k films) and low-dielectric constant barrier films (low-k barrier films). By emitting UV light to the respective films, resistance to leakage current can be improved significantly. In one embodiment of the present invention, UV light is emitted to a film structured by Si—C bond to improve the film's resistance to leakage current. Changing the film structure using UV light emission is particularly effective on films structured by Si—C bond, and the leakage current resistance of a film structured by this bond can be improved without virtually changing the film's mechanical strength. In one embodiment of the present invention, the above action is implemented more effectively by emitting UV light under certain conditions.

This low-dielectric constant film includes a low-dielectric constant barrier film with a dielectric constant of 5 or less (such as between 3 and 5) in one embodiment of the present invention, or it includes a low-dielectric constant interlayer film (low-k film) with a dielectric constant of 4 or less (such as between 2 and 4) and a low-dielectric constant barrier film with a dielectric constant of 5 or less (such as between 3 and 5) in another embodiment. By emitting UV light to these low-dielectric constant films, the resistance of these films to leakage current improves significantly. The effect of improvement in one embodiment of the present invention ranges from twice to 100 times or even more when compared to the levels of leakage current resistance before emission of UV light. In particular, significant improvement can be expected with low-dielectric constant barrier films. In one embodiment of the present invention, emission of UV light to a low-dielectric constant film keeps to a minimum the deterioration of film property manifesting as a rise in dielectric constant and thus prevents the film from being damaged.

A low-k film that comprises the low-dielectric constant film targeted by the present invention includes a low-dielectric constant C-doped silicon oxide film or a film to which nitrogen has been added being wrapped in a low-dielectric constant C-doped silicon oxide film, while a low-dielectric constant barrier film that also comprises the low-dielectric constant film targeted by the present invention includes a silicon carbide film, such as SiC, SiCO or SiCN film, or a low-dielectric constant C-doped silicon oxide film, or a film to which nitrogen has been added being wrapped in a low-dielectric constant C-doped silicon oxide film. This low-dielectric constant barrier film may be provided as an etch stop film or hard mask film.

The present invention not only applies to processed films, but it can also be applied to processing methods and manufacturing methods for such films.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

The present invention is explained further using drawings. It should be noted, however, that the present invention is not at all limited to these drawings.

FIG. 1 is an overview drawing showing an example of the processing apparatus that can be used to implement the present invention. The figure is oversimplified for the purpose of explanation.

FIG. 2 is a graph showing the effect of improvement in the leakage current resistance of a low-k film after UV light is emitted to the film (Example 1).

FIG. 3 is a graph showing the effect of improvement in the leakage current resistance of a SiCO film after UV light is emitted to the film (Example 2).

FIG. 4 is a graph showing the effect of improvement in the leakage current resistance of a SiCN film after UV light is emitted to the film (Example 3).

FIG. 5 is a graph showing the effect of improvement in the leakage current resistance of SiC, SiCO and SiCN films after UV light is emitted to the films (Example 4).

FIG. 6 is a graph showing the relationship of UV light emission time and leakage current (Example 7).

FIG. 7 is a schematic diagram showing an example of the cluster-type apparatus that performs film deposition and emission of UV light.

FIG. 8(a) through 8(i) provide a schematic process drawing showing an example of applying the present invention to the single damascene method.

FIG. 9(a) through 9(i) provide a schematic process drawing showing an example of applying the present invention to the dual damascene method.

### DETAILED DESCRIPTION OF THE PREFERRED EMBODIMENT

The present invention includes the embodiments described below. It should be noted, however, that the present invention is not at all limited to these embodiments.

In an aspect in which one or more objects described above can be achieved, the present invention provides a method of producing an advanced low-dielectric constant film, comprising: (i) depositing a low-dielectric constant film on a substrate, said film being structured by Si—C bond and having a first leakage current; and (ii) emitting ultraviolet (UV) light to the film until the film has a second leakage current which is ½ or less of the first leakage current.

The above embodiment may further include the following embodiments:

The step of UV emission may be continued until the second leakage current is 1/10 or less of the first leakage current.

The film may be selected from any one of the following: (i) a film including Si—O bond as an auxiliary structure; (ii) a film constituted by SiC, SiCO, or SiCN; (iii) a film having a first mechanical strength and a second mechanical strength before and after the step of UV emission, respectively, wherein the second mechanical strength is substantially the same as the first mechanical strength through the step of UV emission; (iv) a film having a modulus of 10 GPa or more and a hardness of 2 GPa or more before the step of UV emission; (v) a film which serves as a barrier layer having a dielectric constant of 3-5.

The UV may have a wave length of between 100 nm and 500 nm. The UV may be emitted at an intensity of between 1 W/cm² and 100 W/cm².

The step of UV emission may be the sole curing step for the film, wherein the film has a desired mechanical strength prior to the step of UV emission.

The method may further comprise, prior to the step of film deposition, depositing a low-k film on the substrate. The method may further comprise emitting UV light to the low-k film before depositing the barrier layer. In the above, the barrier layer may serve as an etch stop or hard mask.

The barrier layer may have a leakage current on the order of 10⁻⁹ A/cm or 10⁻¹⁰ A/cm at an electric field of 2 MV/cm.

In another aspect in which one or more objects described above can be achieved, the present invention provides a method for forming a multilayer structure, comprising: (I) forming a low-k film on a substrate; (II) curing the low-k film solely by emitting UV light thereto; (III) forming a barrier layer on the low-k film; and (IV) curing the barrier layer solely by emitting UV light thereto. This method can be applied to any suitable single or dual damascene method.

The above embodiment may further include the following embodiments:

The barrier layer may serve as an etch stop or hard mask. Before and after the step of curing the barrier layer, the barrier layer may have a first leakage current and a second leakage current, respectively, and the step of curing the barrier layer may be continued until the second leakage current is ½ or less of the first leakage current. The step of curing the barrier layer may be continued until the second leakage current is 1/100 or less of the first leakage current.

The step of curing the barrier layer may be conducted without substantially changing a mechanical strength of the barrier layer prior to the step of curing the barrier layer.

The low-k film may be constituted by C-doped silicon oxide or N-added, C-doped silicon oxide. The barrier layer may be constituted by O-doped silicon carbide or N-doped silicon carbide.

In all of the aforesaid aspects and embodiments, any element used in an aspect or embodiment can interchangeably be used in another aspect or embodiment unless such a replacement is not feasible or causes adverse effect.

The following explains the preferred embodiments of the present invention in further details.

Improvement in a film's resistance to leakage current after emission of UV light to the film is embodied most effectively when the film is structured by Si—C bond. The second greatest improvement effect is achieved on a film structured by Si—O bond. In one preferred embodiment of the present invention, therefore, the target film is structured by Si—C bond. The next preferred target film is one in which Si—O bond is involved in the structuring of the film as a reinforcement. A film “structured” by a certain bond means that the film cannot be formed without the bond. In one embodiment of the present invention, a single bond accounts for one-half or more (or in some cases 80 percent or more) of all bonds involved in the structuring of the film. In another embodiment, the target film includes a low-k film.

In another embodiment of the present invention, the target film can be functionally defined. To be specific, the target film is defined as an etch stop film, hard mask film or other barrier film. A low-k film becomes an additional target of processing. When forming a multilayer structure, multiple different low-dielectric constant films are laminated. In this case, emission of UV light to the low-dielectric constant films, such as low-k films, is effective.

In yet another embodiment of the present invention, the target film can be characteristically defined. To be specific, the target film is one whose mechanical strength does not virtually improve after UV light is emitted to the film (improvement is minimal, if any, and the film's mechanical strength does not improve at all or even decreases in some embodiments). In one embodiment, such film already has very high mechanical strength before being treated with UV light. By emitting UV light to a film having such a stable structure that emission of UV light does not improve the film's strength, the film's resistance to leakage current can be effectively improved. In one embodiment, UV light is emitted to a film with a modulus of 10 GPa or more, or preferably 50 GPa or more, and/or a hardness of 2 GPa or more, or preferably 7 GPa or more.

Emission of UV light can be implemented by placing a substrate on which a film has been deposited into a UV light emission apparatus. It is also possible to deposit a film and emit UV light to the deposited film using a single apparatus that has been constructed by attaching a UV light emission apparatus to a CVD apparatus or other apparatus used to implement film deposition. However, it is desirable to structurally separate the UV light emission apparatus and the film deposition apparatus.

In one embodiment of UV light emission, a chamber is filled with gas selected from Ar, CO, CO₂, C₂H₄, CH₄, H₂, He, Kr, Ne, N₂, N₂O, O₂, Xe, alcohol-based CH gases or organic gases (the flow rate is adjusted to between approx. 0.1 sccm and approx. 20 slm, or preferably to between approx. 500 sccm and approx. 10,000 sccm, in one embodiment), and the ambient pressure is adjusted to between approx. 0.1 torr and near the atmospheric pressure. Then, a substrate to be processed is placed on a heater that has been set to between approx. 0° C. and approx. 650° C., and UV light with a wavelength of between approx. 100 nm and approx. 400 nm and an intensity of approx. 1 mW/cm² and approx. 1,000 mW/cm², or preferably between approx. 1 mW/cm² and approx. 100 mW/cm², or more preferably between approx. 5 mW/cm² and approx. 50 mW/cm², is emitted to a film on the semiconductor substrate from an appropriate distance from UV light emitters (between approx. 5 mm and approx. 60 mm, or preferably between approx. 10 mm and approx. 40 mm, in one embodiment), either continuously or at a pulse frequency of between 0 and approx. 1,000 Hz (the process time may be set to between approx. 5 seconds and approx. 300 seconds, or preferably between approx. 20 seconds and approx. 200 seconds, or more preferably between approx. 30 seconds and approx. 100 seconds). This semiconductor manufacturing apparatus is able to perform the above series of processing steps based on an automated sequence, wherein the processing steps comprises introduction of gas, emission of UV light, stopping of emission, and stopping of gas. Depending on the specific embodiment of the present invention, the values indicating ranges in the above explanation, or in the explanations that follow, may or may not be included in the applicable range.

In one embodiment of the present invention, the parameters required in the UV light emission process include pressure, temperature, emission time, environment, wavelength, intensity and distance between the lamp and heater. One effective process condition is to use UV light with a wavelength of between 150 nm and 300 nm. The intensity of UV light varies in accordance with the wavelength, and is normally between approx. 1 mW/cm² and approx. 10 mW/cm² when the wavelength of UV light is between 150 nm and 200 nm (especially when the wavelength is between approx. 172 nm and 185 nm). The intensity is between approx. 10 mW/cm² and approx. 100 mW/cm² when the wavelength of UV light is between 200 nm and 250 nm (especially when the wavelength is approx. 222 nm), and becomes between approx. 100 mW/cm² and approx. 1,000 mW/cm² when the wavelength of UV light is between 250 nm and 300 nm (especially when the wavelength is approx. 254 nm). In other words, UV light whose wavelength is between 150 nm and 300 nm is effective in changing the structure of a film to improve the film's resistance to leakage current. At a wavelength of between 150 nm and 300 nm, the intensity is set between approx. 1 mW/cm² and approx. 200 mW/cm² (including a range of between 3 and 100 mW/cm² and another between 5 and 70 mW/cm²) in one embodiment of the present invention. If the intensity is raised beyond the above ranges, the film structure will change excessively, thus causing the bonded molecules to collapse and eventually damaging the film.

In a preferred embodiment of the present invention, the process temperature during UV light emission is between 300° C. and 650° C. (or preferably between 350° C. and 550° C.). Although the emission time varies in accordance with the wavelength and intensity of UV light, it is normally between 5 seconds and 5 minutes (or preferably between 30 seconds and 3 minutes) for a low-K film, and between 30 seconds and 15 minutes (or preferably between 2 minutes and 10 minutes) for a low-dielectric constant barrier film. In one embodiment of the present invention, the reference emission time is set to 30 seconds or more (including 1 minute, 5 minutes, 10 minutes, 15 minutes and any values in between) when UV light with a wavelength of between 150 and 300 nm and an intensity of 10 mW/cm² is used. If UV light with a different intensity is used, the emission time is adjusted to obtain the same resistance to leakage current. Also, the emission environment (pressure adjustment gas) should preferably comprise N₂, He or Ar.

The improvement ratio of resistance to leakage current (calculated by dividing the leakage current before UV emission by the leakage current after UV emission) is twice or more (including 5 times or more, 10 times or more, 30 times or more, 50 times or more, 100 times or more, 150 times or more and any values in between, but preferably 10 times or more) in one embodiment of the present invention.

In another embodiment of the present invention, emission of UV light can be implemented at a wavelength of between approx. 100 nm and approx. 500 nm (or preferably between approx. 100 nm and approx. 400 nm) and a total intensity combining the outputs from all emitters ranging between approx. 1 mW/cm² and approx. 1,000 mW/cm² (including 2 mW/cm², 5 mW/cm², 10 mW/cm², 50 mW/cm², 100 mW/cm², 200 mW/cm² and any values in between, but preferably between approx. 1 mW/cm² and approx. 50 mW/cm²). For your reference, the apparatus used in the aforementioned embodiments is not used to deposit films, but to modify deposited films. Therefore, the apparatus does not require energy for depositing films.

In one embodiment of the present invention, a semiconductor multilayer structure comprising low-k and barrier films is formed. An example of the UV light emission process in the forming of a semiconductor multilayer structure is given below. It should be noted, however, that the present invention is not at all limited to this example.

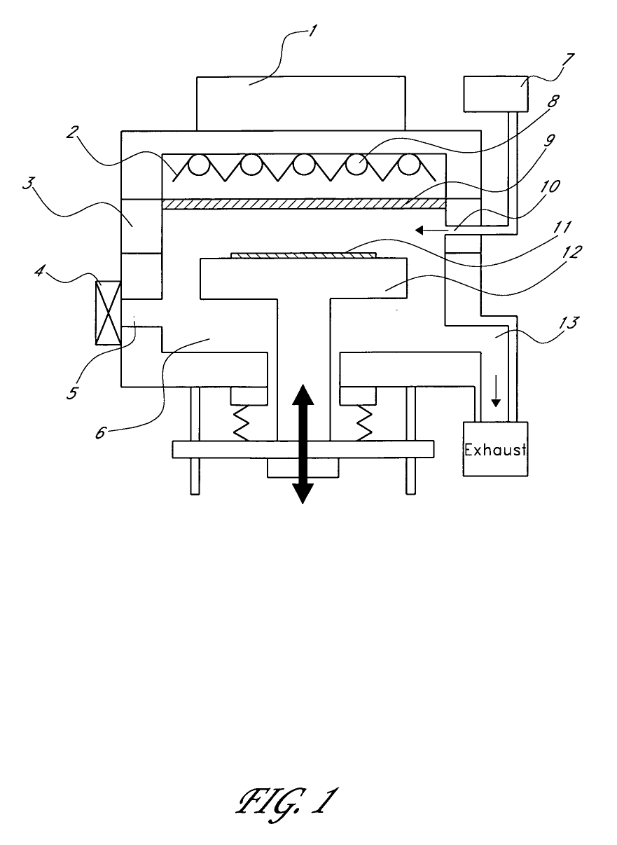

FIG. 1 is an outline drawing showing an example of the processing apparatus that can be used to implement the present invention. The figure is oversimplified for the purpose of explanation. As shown in FIG. 1, the apparatus comprises a chamber (6) that can control the ambient pressure in a range from vacuum to atmospheric pressure and a UV light emission unit (1) installed on top of the aforementioned chamber. The apparatus further comprises UV light emitters (8) that emit continuous or pulsed light, a heater (12) installed in parallel with and opposing the UV light emitters (8), and a filter (9) installed in parallel with and opposing the UV light emitters (8) and heater (12) between the emitters and heater. The UV light emission unit (1) stores a transformer and other resistances and a control board used for controlling the emission. Installing the unit on top of the chamber is preferable as it saves space, but the unit can also be separated from the chamber or installed next to the chamber. The filter (9) is placed on top of flanges (3) via an O-ring (not shown in the figure). Placed on the heater (12) is a target to be processed (11) that is carried in/out through a substrate access port (5) via a gate valve (4). Gas is supplied into the chamber (6) from a gas supply source (7) via a gas inlet (10) (only one gas inlet may be provided, but it is preferable to provide multiple gas inlets, as explained later). The gas inside the chamber (6) is discharged from the chamber through an exhaust outlet (13). Reflection panels (2) are provided along the UV light emitters (8) so that both direct light and reflected light reach the filter (9). The reflection panels (2), heater (12) and flanges (3) may be constructed using aluminum, for example. One example of this apparatus is disclosed in U.S. patent application Ser. No. 11/040,863 (filed on Jan. 21, 2005) whose assignee is the same as the assignee for the present patent application. The entire content of this application is incorporated herein by reference.

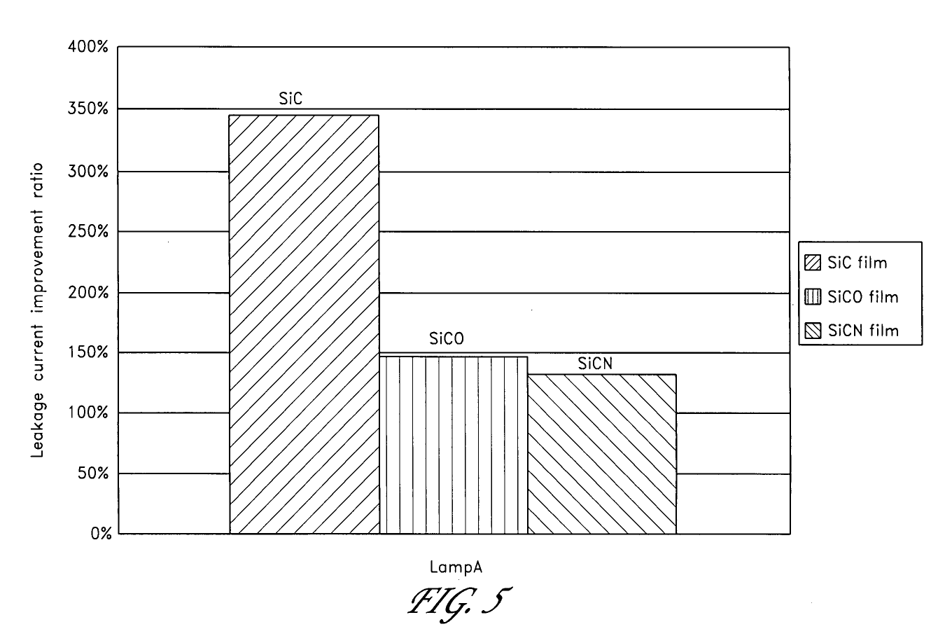

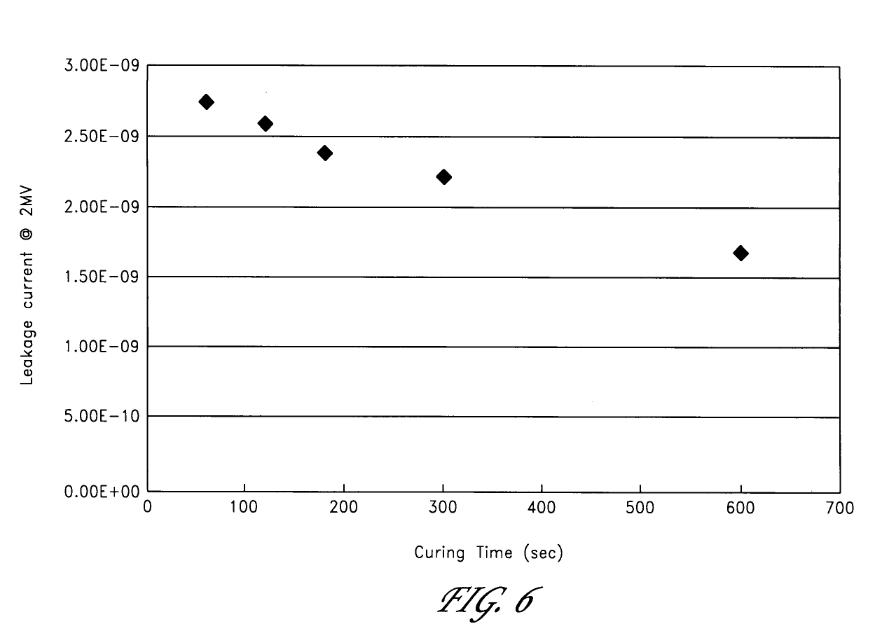

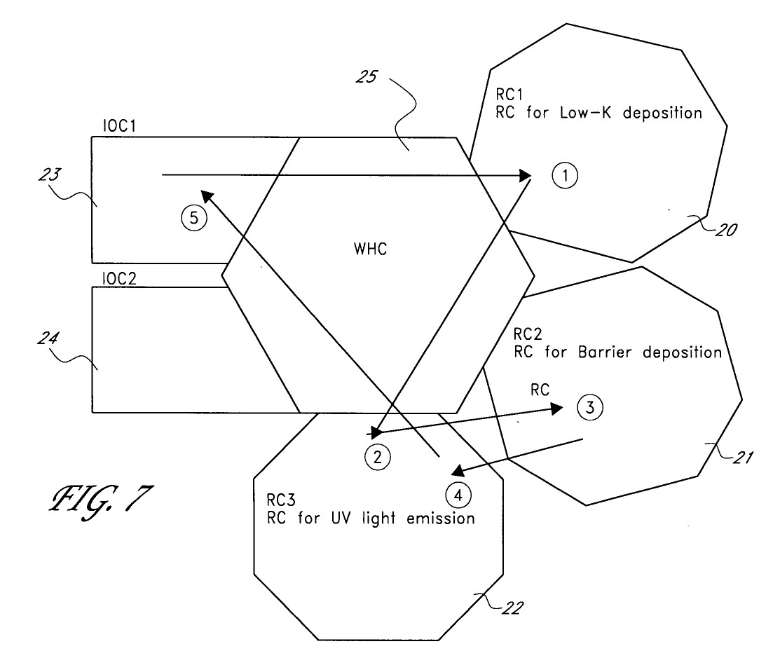

The steps to apply UV light emission in one example of the single damascene method are explained by referring to FIG. 8 (a) through (i).

Step a) Deposit a passivation protection film (32) on an insulation film (31) on a semiconductor substrate (30) and also on a metal wiring (33) embedded into the insulation film.

Step b) Deposit a first layer of low-k film (34) on the passivation film (32).

Step c) Emit UV light from above the low-k film (34) to modify the low-k film.

Step d) Deposit a hard mask (35) on top of the low-k film (34), and then emit UV light to modify the hard mask (35). The hard mask is a low-dielectric constant barrier film made of SiC, SiCN, SiCO or SiOC.

Step e) Etch the hard mask film (35) and low-k film (34) to create a via opening (36) for embedding metal wiring. Deposit a barrier metal along the via opening (36), deposit a copper seed on the barrier metal, and apply copper plating by means of an electroplating or non-electroplating method (not shown in the figure). After copper plating, smoothen the surface using CMP.

Step f) Deposit a SiC, SiCN, SiCO or SiN film on the copper plating as an etch stop, and then emit UV light to modify the etch stop film (37). The etch stop film (37) is a low-dielectric constant barrier film made of SiC, SiCN or SiCO.

Step g) Deposit a second layer of low-k film (38) on the etch stop film, and then emit UV light to modify the low-k film (38).

Step h) Deposit a hard mask (39) on top of the low-k film (38), and then emit UV light to modify the hard mask (39). The hard mask (39) is a low-dielectric constant barrier film made of SiC, SiCN or SiCO.

Step i) Etch the hard mask film (39) and low-k film (38) to create a trench opening (40) for embedding metal wiring. Deposit a barrier metal along the trench opening, deposit a copper seed on the barrier metal, and apply copper plating by means of an electroplating or non-electroplating method (not shown in the figure). After copper plating, smoothen the surface using CMP.

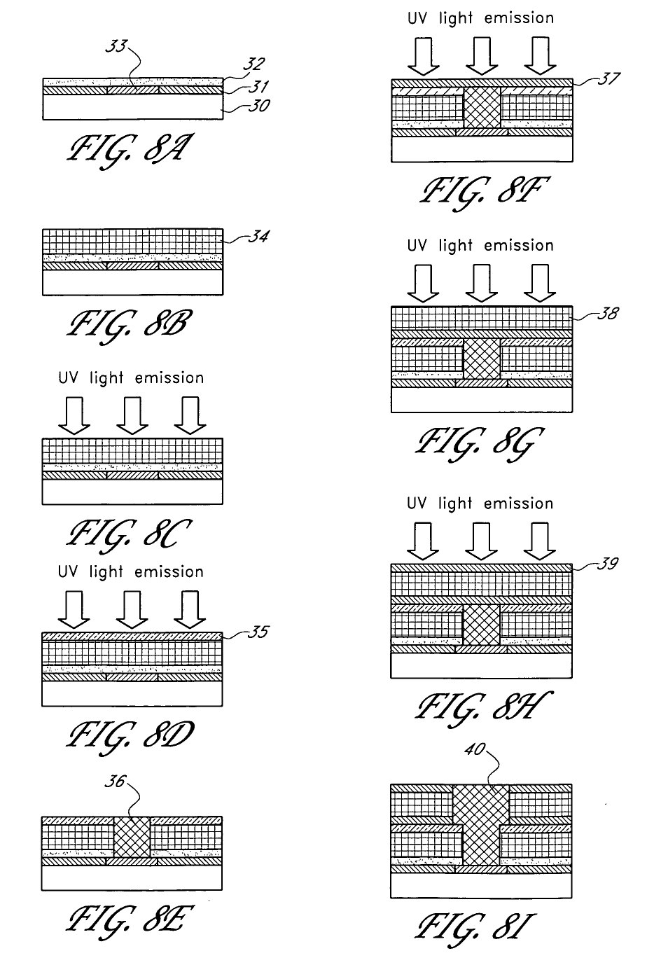

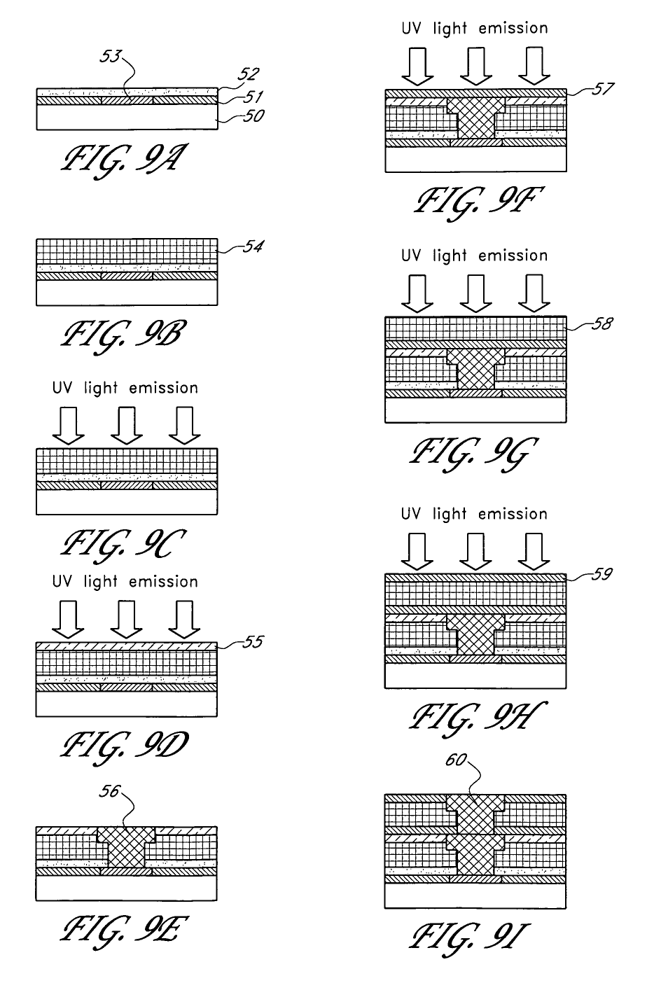

Next, the steps to apply UV light emission in one example of the dual damascene method are explained by referring to FIG. 9 (a) through (i).

Step a) Deposit a passivation protection film (52) on an insulation film (51) on a semiconductor substrate (50) and also on a metal wiring (53) embedded into the insulation film.

Step b) Deposit a first layer of low-k film (54) on the passivation film (52).

Step c) Emit UV light from above the low-k film (54) to modify the low-k film (54).

Step d) Deposit a hard mask (55) on top of the low-k film (54), and then emit UV light to modify the hard mask (55). The hard mask (55) is a low-dielectric constant barrier film made of SiC, SiCN, SiCO or SiOC.

Step e) Etch the hard mask film (55) and low-k film (54) to create a via/trench opening (56) for embedding metal wiring. Deposit a barrier metal along the via/trench opening (56), deposit a copper seed on the barrier metal, and apply copper plating by means of an electroplating or non-electroplating method (not shown in the figure). After copper plating, smoothen the surface using CMP.

Step f) Deposit a SiC, SiCN, SiCO or SiN film on the copper plating as an etch stop, and then emit UV light to modify the etch stop film (57). The etch stop film (57) is a low-dielectric constant barrier film made of SiC, SiCN or SiCO.

Step g) Deposit a second layer of low-k film (58) on the etch stop film, and then emit UV light to modify the low-k film (58).

Step h) Deposit a hard mask (59) on top of the low-k film (58), and then emit UV light to modify the hard mask (59). The hard mask (59) is a low-dielectric constant barrier film made of SiC, SiCN or SiCO.

Step i) Etch the hard mask film (59) and low-k film (58) to create a via/trench opening (60) for embedding metal wiring. Deposit a barrier metal along the via/trench opening (60), deposit a copper seed on the barrier metal, and apply copper plating by means of an electroplating or non-electroplating method (not shown in the figure). After copper plating, smoothen the surface using CMP.

Application to the damascene methods is not at all limited to the examples given above, and the technologies disclosed in U.S. Pat. Nos. 5,246,885, 5,262,354, 6,100,184, 6,140,226, 6,177,364, 6,211,092, 6,815,332, etc., can also be applied, for example. The entire contents of these patents are incorporated herein by reference.

In the aforementioned damascene methods, UV light is also emitted to the low-k films. However, emission of UV light to the low-k films is not required in some embodiments of the present invention. Low-k films normally provide higher resistance to leakage current than barrier films do, so there is no compelling need to emit UV light to low-k films to improve their resistance to leakage current. However, it is possible to emit UV light to low-k films to improve their mechanical strength and also reduce their dielectric constant. On the other hand, barrier films naturally have high mechanical strength and therefore improvement in their mechanical strength is virtually zero after emission of UV light (any improvement is significantly smaller than what can be achieved with low-k films). In one embodiment of the present invention, the dielectric constant of the barrier film does drop but not significantly, while the film's resistance to leakage current improves considerably. In general, barrier films are required to have high resistance to leakage current, so improvement in the leakage current resistance of barrier films provides a great advantage.

In the above examples, the low-dielectric constant barrier films serve as a hard mask film or etch stop film. It should be noted, however, that low-dielectric constant barrier films can be used to provide other functions.

In one embodiment of applying the present invention to a damascene method, the thickness of low-k film is between 100 and 1,000 nm (or preferably between 100 and 500 nm or so to reflect the current trend for thinner films for use in devices of more minute structures). In one embodiment of the present invention, the thickness of barrier film is between 10 and 100 nm (for the same reason mentioned with respect to low-k films, a range of between 20 and 50 nm or so is more preferred at the present).

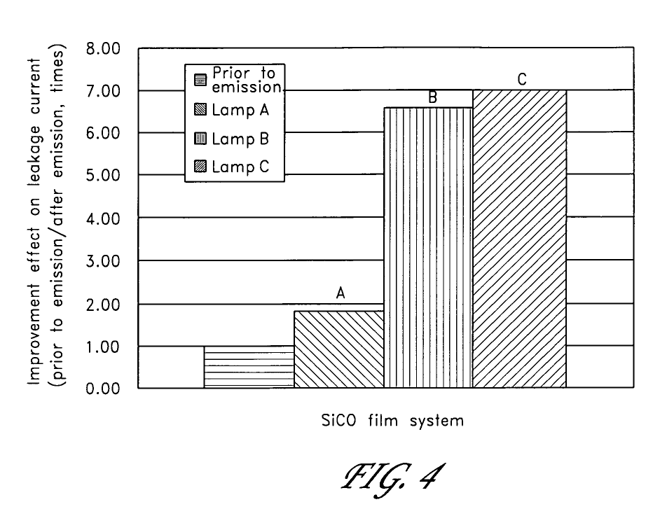

As an example of how a UV light emission process can be incorporated into the forming of semiconductor multilayer structure, as explained above, a cluster-type semiconductor manufacturing apparatus shown in FIG. 7 can be used, wherein, among reaction chambers connected to a wafer delivery chamber (25), one reaction chamber (22) is used for emission of UV light, another reaction chamber (20) is used for deposition of low-k film, and yet another reaction chamber (21) is used for deposition of barrier film. For example, the following sequence can be implemented using this apparatus: [1] load a wafer from a load lock chamber (23) into the reaction chamber for deposition of low-k film (20) via the wafer delivery chamber (25) and deposit a low-k film on the wafer; [2] after a low-k film has been deposited on the wafer, load the wafer into the reaction chamber for emission of UV light (22) via the wafer delivery chamber (25) and emit UV light to the low-k film; [3] after UV light has been emitted to the low-k film, load the wafer into the reaction chamber for deposition of barrier film (21) via the wafer delivery chamber (25) (the arrow does not pass through the wafer delivery chamber, but this is for simplification of illustration and the wafer does pass through the delivery chamber in the actual sequence) and deposit a barrier film on the wafer; [4] after a barrier film has been deposited on the wafer, load the wafer into the reaction chamber for emission of UV light (22) via the wafer delivery chamber (25) (the arrow does not pass through the wafer delivery chamber, but this is for simplification of illustration and the wafer does pass through the delivery chamber in the actual sequence) and emit UV light to the barrier film; and [5] after UV light has been emitted to the barrier film, return the wafer into the load lock chamber (23) via the wafer delivery chamber (25).

Without using the apparatus explained above, film deposition and UV light emission can also be implemented using multiple reaction chambers.

In one embodiment of the present invention, improvement of film properties via emission of UV light is carried out in one complete step. In other words, film properties can be improved without providing thermal annealing, etc., after the UV light emission step. In this case, a semiconductor multilayer structure can be formed only by combining a film deposition step and a UV light emission step. To support this notion, in the above example only three reaction chambers are used to form a multilayer structure without annealing, etc. In another embodiment of the present invention, annealing or other treatment may be provided, but if annealing is provided, for example, it is performed under less strict conditions than regular annealing.

The target film is not limited, but a low-dielectric constant C-doped silicon oxide film or silicon carbide film being deposited on a semiconductor substrate can be used. Such silicon-based low-dielectric constant films can be formed by using a silicon compound containing hydrocarbon as a precursor.

For example, a film formed by materials including at least one material expressed by any of chemical formulas 1 to 7 can be used to implement the present invention. The materials disclosed in U.S. Pat. Nos. 6,455,445 and 6,881,683 can also be used, and the films disclosed in these patents can be applied. The entire contents of the above U.S. patents are incorporated herein by reference. 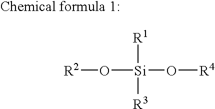
(In the formula, R¹, R², R³ and R⁴ are any of CH₃, C₂H₅, C₃H₇ and C₆H₅.)

Compounds expressed by chemical formula 1 above include DMDMOS (dimethyl dimethoxysilane) and DEDEOS (diethyl diethoxyoxysilane). 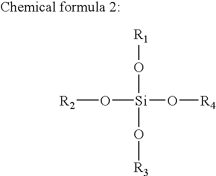
(In the formula, R¹, R², R³ and R⁴ are any of CH₃, C₂H₅, C₃H₇ and C₆H₅.)

Compounds covered by chemical formula 2 include TMOS (tetramethoxysilane). 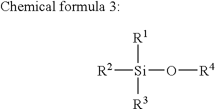
(In the formula, R¹, R², R³ and R⁴ are any of CH₃, C₂H₅, C₃H₇ and C₆H₅.)

Compounds covered by chemical formula 3 include PTMOS (phenyl trimethoxysilane). 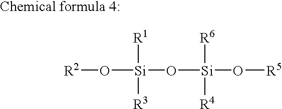
(In the formula, R¹, R², R³, R⁴, R⁵ and R⁶ are any of CH₃, C₂H₅, C₃H₇ and C₆H₅.)

Compounds covered by chemical formula 4 include DMOTMDS (1,3-dimethoxytetramethyl disiloxane). 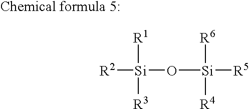
(In the formula, R¹, R², R³, R⁴, R⁵ and R⁶ are any of CH₃, C₂H₅, C₃H₇ and C₆H₅.)

Compounds covered by chemical formula 5 include HMDS (hexamethyl disilane). 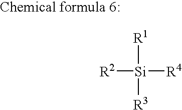
(In the formula, R¹, R², R³ and R⁴ are any of CH₃, C₂H₅, C₃H₇ and C₆H₅.)

Compounds covered by chemical formula 6 include DVDMS (divinyl dimethylsilane) and 4MS (tetramethyl silane). 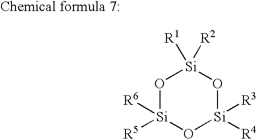
(In the formula, R¹, R², R³, R⁴, R⁵ and R⁶ are any of CH₃, C₂H₃, C₂H₅, C₃H₇ and C₆H₅.)

Compounds covered by chemical formula 7 include OMCTS (octamethyl cyclotrisiloxane).

If the material does not contain oxygen atoms, as is the case of chemical formula 6, oxygen atoms can be added separately by introducing an oxidizing gas. To add nitrogen atoms separately, it can be done by introducing a nitriding gas.

As for the method to deposit barrier films made of SiC, SiCO, SiCN, etc., those disclosed in U.S. Published Patent Application Nos. 2004/0161535, 2004/0076767 and 2005/0009320 (all of which has the same assignee as the assignee for the present patent application) can be applied as deemed appropriate. The entire contents of these published patent applications are incorporated herein by reference.

### EXAMPLES

Examples of the present invention are explained below. It should be noted, however, that the present invention is not at all limited to these examples.

The wavelengths and intensities of the UV light emitters used in the examples are listed below:

Lamp A: Wavelength between 100 and 400 nm; Intensity 10 mW/cm² (per unit surface area of the substrate)

Lamp B: Wavelength between 200 and 400 nm; Intensity 5 mW/cm²

Lamp C: Wavelength between 200 and 500 nm; Intensity 100 mW/cm²

Leakage current was measured at a voltage of 2 MV/cm², and leakage currents of each film before and after UV light emission were compared against each other, with the level measured before UV light emission being 1.

The deposition conditions of each film are as follows:

Low-k Film:
Material DMOTMDS (1,3-dimethoxytetramethyl disiloxane): 200 sccm
O₂ gas: 200 sccm
He: 200 sccm
RF power output: 900 W (27.12 MHz)
Substrate temperature: 360° C.
Pressure: 5 torr

SiCO Film:
Material 4MS (tetramethyl silane): 300 sccm
O₂ gas: 2,000 sccm
He: 3,000 sccm
RF power output: 600 W (27.12 MHz)+65 W (430 kHz)
Substrate temperature: 350° C.
Pressure: 4 torr

SiCN Film:
Material 4MS (tetramethyl silane): 200 sccm
NH₃ gas: 300 sccm
He: 3,000 sccm
RF power output: 450 W (27.12 MHz)+130 W (430 kHz)
Substrate temperature: 400° C.
Pressure: 5 torr

### Example 1

UV light was emitted to a low-k film using lamp A, B or C, and improvement in the film's resistance to leakage current was examined. The film thickness was 500 nm. The emission conditions were: pressure 50 torr, temperature 430° C., N₂ flow rate 4 slm and emission time 60 seconds for lamp A; pressure 760 torr, temperature 400° C., N₂ flow rate 4 slm and emission time 240 seconds for lamp B; and pressure 760 torr, temperature 400° C., N₂ flow rate 4 slm and emission time 480 seconds for lamp C. Leakage current was measured before and after the processing, and the ratio of improvement (in times) was calculated. The results are shown in the table below and in FIG. 2.

| | | Before | After | Improve- |
|---|---|---|---|---|
| | | emission | emission | ment |
| | | (A/cm) | (A/cm) | (times) |
| Low-k | Lamp A | 6.98E−09 | 2.450E−09 | 2.85 |
| film | Lamp B | 6.98E−09 | 4.510E−10 | 15.48 |
| | Lamp C | 6.98E−09 | 2.230E−10 | 31.30 |

As shown above, lamp C with a high intensity improved the leakage current resistance of a low-k film by 30 times or more without damaging the film (refer to Example 6).

### Example 2

UV light was emitted to a SiCO film using lamp A, B or C, and improvement in the film's resistance to leakage current was examined. The film thickness was 200 nm. The emission conditions were: pressure 50 torr, temperature 430° C., N₂ flow rate 4 slm and emission time 30 seconds for lamp A; pressure 760 torr, temperature 400° C., N₂ flow rate 4 slm and emission time 120 seconds for lamp B; and pressure 760 torr, temperature 400° C., N₂ flow rate 4 slm and emission time 120 seconds for lamp C. Leakage current was measured before and after the processing, and the ratio of improvement (in times) was calculated. The results are shown in the table below and in FIG. 3.

| | | Before | After | Improve- |
|---|---|---|---|---|
| | | emission | emission | ment |
| | | (A/cm) | (A/cm) | (times) |
| SiCO film | Lamp A | 8.99E−08 | 4.60E−09 | 19.54 |
| | Lamp B | 8.99E−08 | 3.92E−09 | 22.93 |
| | Lamp C | 8.99E−08 | 5.40E−10 | 166.48 |

As shown above, lamp C improved the leakage current resistance of a SiCO film quite significantly by 150 times or more without damaging the film (refer to Example 6).

### Example 3

UV light was emitted to a SiCN film using lamp A, B or C, and improvement in the film's resistance to leakage current was examined. The film thickness was 200 nm. The emission conditions were: pressure 50 torr, temperature 430° C., N₂ flow rate 4 slm and emission time 30 seconds for lamp A; pressure 760 torr, temperature 400° C., N₂ flow rate 4 slm and emission time 120 seconds for lamp B; and pressure 760 torr, temperature 400° C., N₂ flow rate 4 slm and emission time 120 seconds for lamp C. Leakage current was measured before and after the processing, and the ratio of improvement (in times) was calculated. The results are shown in the table below and in FIG. 3.

| | | Before | After | Improve- |
|---|---|---|---|---|
| | | emission | emission | ment |
| | | (A/cm) | (A/cm) | (times) |
| SiCN film | Lamp A | 3.80E−09 | 2.07E−09 | 1.84 |
| | Lamp B | 3.80E−09 | 5.79E−10 | 6.56 |
| | Lamp C | 3.80E−09 | 5.46E−10 | 6.96 |

As shown above, although the improvements in leakage current resistance after emission of UV light were not as notable as those seen on other films, lamps B and C still improved the resistance by 5 times or more.

### Example 4

UV light was emitted to each film using lamp A and the ratio of improvement in the film's resistance to leakage current was calculated. SiC, SiCO and SiCN films were tested. The thickness of each film was 200 nm, and UV light was emitted under the conditions of pressure 50 torr, temperature 430° C., emission time 30 seconds and N₂ flow rate 4 slm. Leakage current was measured before and after the processing, and the ratio of improvement in leakage current resistance was calculated. The results are shown in FIG. 5. As shown in FIG. 5, when UV light was emitted using lamp A for a very short period of time of 30 seconds, the films exhibited improvements in their leakage current resistance in the order of SiC>SiCO>SiCN. The ratio of improvement was particularly high with the SiC film. Although the difference between SiCO and SiCN is not prominent under the conditions of FIG. 5, extending the emission time improves the SiCO film's leakage current resistance by 20 times under lamp A, as suggested by FIG. 3 explained earlier, while the improvement in the SiCN's resistance is less than twice.

### Example 5

UV light was emitted to each film using lamp A and the change in the film's mechanical strength was calculated. Low-k, SiCO and SiCN films were tested. The emission conditions were: pressure 50 torr, temperature 430° C. and N₂ flow rate 4 slm. With the low-k film, the thickness was 500 nm and the emission time was 60 seconds. With the SiCO and SiCN films, the thickness was 1,000 nm and the emission time was 120 seconds. The modulus and hardness of each film were measured before and after the processing. The results are shown below.

| | | Before | After |
|---|---|---|---|
| | | emission | emission |
| | | (GPa) | (GPa) |
| Low-k film | Modulus | 5.2 | 7.65 |
| | Hardness | 0.95 | 1.39 |
| SiCO film | Modulus | 84.5 | 85 |
| | Hardness | 12.4 | 12.2 |
| SiCN film | Modulus | 89.5 | 89 |
| | Hardness | 12.6 | 12.2 |

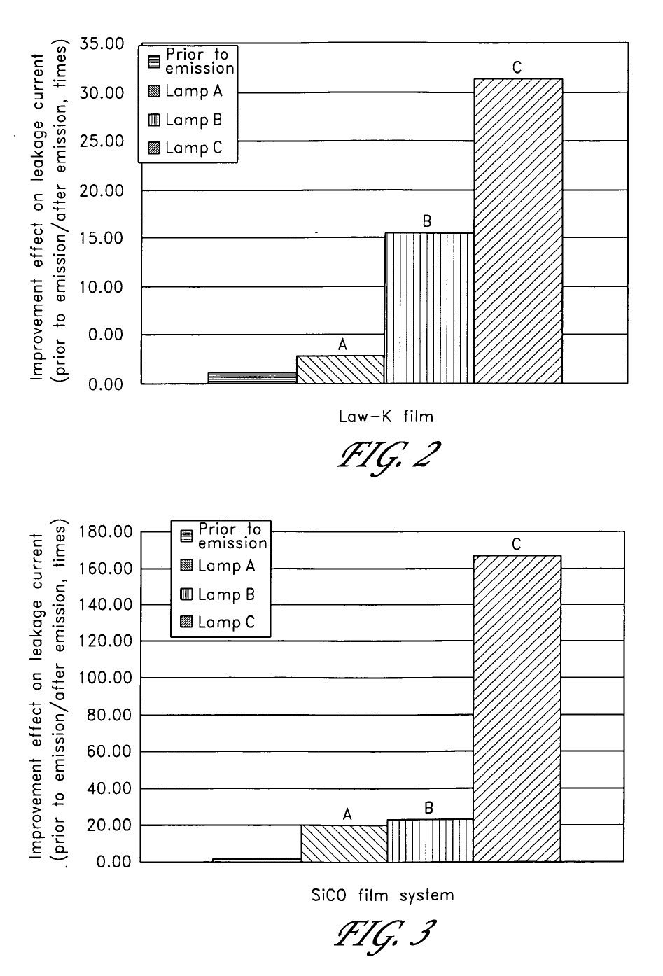

As evident from the above table, the SiCO and SiCN films had virtually no improvement in their mechanical strength after emission of UV light. One possible reason for this is that these barrier films had high mechanical strength to begin with. As suggested from FIGS. 3 and 4, these films do exhibit notable improvements in their leakage current resistance.

### Example 6

UV light was emitted to each film using lamp A, B or C, and the change in the film's dielectric constant was calculated. Low-k, SiCO and SiCN films were tested. The emission conditions for lamp A were: pressure 50 torr, temperature 430° C. and N₂ flow rate 4 slm. With the low-k film, the thickness was 500 nm and the emission time was 60 seconds. With the SiCO and SiCN films, the thickness was 200 nm and the emission time was 30 seconds. The emission conditions for lamp B were: pressure 760 torr, temperature 400° C. and N₂ flow rate 4 slm. With the low-k film, the thickness was 500 nm and the emission time was 240 seconds. With the SiCO and SiCN films, the thickness was 200 nm and the emission time was 120 seconds. The emission conditions for lamp C were: pressure 760 torr, temperature 400° C. and N₂ flow rate 4 slm. With the low-k film, the thickness was 500 nm and the emission time was 480 seconds With the SiCO and SiCN films, the thickness was 200 nm and the emission time was 120 seconds. The dielectric constant of each film was calculated before and after the processing. The results are shown below.

| | Before emission | After emission |
|---|---|---|
| Lamp A | | |
| Low-k film | 2.62 | 2.588 |
| SiCO film | 4.21 | 4.14 |
| SiCN film | 4.53 | 4.42 |
| Lamp B | | |
| Low-k film | 2.615 | 2.599 |
| SiCO film | 4.23 | 4.21 |
| SiCN film | 4.47 | 4.45 |
| Lamp C | | |
| Low-k film | 2.636 | 2.602 |
| SiCO film | 4.24 | 4.19 |
| SiCN film | 4.48 | 4.45 |

As evident from above, the dielectric constant of each film dropped after emission of UV light regardless of the type of lamp, but the change was not significant. In no case did the dielectric constant increase, suggesting that the films were not damaged under the above emission conditions. As suggested from FIGS. 2, 3, and 4, the leakage current resistance notably improved in all cases, with lamp C associated with significant improvements in particular. There is no correlation between the improvement in leakage current resistance and improvement in dielectric constant.

### Example 7

UV light was emitted to a SiCO film using lamp A, and the relationship of emission time and leakage current was examined. The film thickness was 200 nm. The emission conditions were: pressure 50 torr, temperature 430° C. and N₂ flow rate 4 slm. The results are shown in FIG. 6.

As evident from FIG. 6, the leakage current dropped after UV emission even under lamp A when the emission time was increased. In Example 2, the emission time was 30 seconds for lamp A and 120 seconds for lamp B. FIG. 6 shows that even under lamp A, if the emission time is increased to 120 seconds, the leakage current resistance improves by approx. 35 times (2.6E-09), which exceeds the level of improvement achieved under lamp B (approx. 22 times). If the emission time is increased to 600 seconds, the leakage current resistance improves by approx. 53 times (1.7E-09).

Based on the above results, the embodiments of the present invention are able to effectively improve leakage current resistance of films used on semiconductor devices to very high levels not heretofore possible, and therefore the present invention can be utilized to improve the quality of semiconductor devices in the future.

What is claimed is:

1. A method of producing an advanced low-dielectric constant film, comprising:
depositing a low-dielectric constant film on a substrate, said film being structured by Si—C bond and having a first leakage current; and
emitting ultraviolet (UV) light to the film until the film has a second leakage current which is ½ or less of the first leakage current.

2. The method according to claim 1, wherein the step of UV emission is continued until the second leakage current is 1/10 or less of the first leakage current.

3. The method according to claim 1, wherein the film includes Si—O bond as an auxiliary structure.

4. The method according to claim 1, wherein the film is constituted by SiC, SiCO, or SiCN.

5. The method according to claim 1, wherein before and after the step of UV emission, the film has a first mechanical strength and a second mechanical strength, and the step of UV emission is continued wherein the second mechanical strength is substantially the same as the first mechanical strength.

6. The method according to claim 1, wherein the film has a modulus of 10 GPa or more and a hardness of 2 GPa or more before the step of UV emission.

7. The method according to claim 1, wherein the film is a barrier layer having a dielectric constant of 3-5.

8. The method according to claim 1, wherein the UV has a wave length of between 100 nm and 500 nm.

9. The method according to claim 1, wherein the UV is emitted at an intensity of between 1 W/cm² and 100 W/cm².

10. The method according to claim 1, wherein the step of UV emission is the sole curing step for the film, wherein the film has a desired mechanical strength prior to the step of UV emission.

11. The method according to claim 7, further comprising, prior to the step of film deposition, depositing a low-k film on the substrate.

12. The method according to claim 11, further comprising emitting UV light to the low-k film before depositing the barrier layer.

13. The method according to claim 12, wherein the barrier layer serves as an etch stop or hard mask.

14. The method according to claim 1, wherein the barrier layer has a leakage current on the order of 10⁻⁹ A/cm at an electric field of 2 MV/cm.

15. The method according to claim 1, wherein the barrier layer has a leakage current on the order of 10⁻¹⁰ A/cm at an electric field of 2 MV/cm.

16. A method for forming a multilayer structure, comprising:
forming a low-k film on a substrate;
curing the low-k film solely by emitting UV light thereto;
forming a barrier layer on the low-k film; and
curing the barrier layer solely by emitting UV light thereto.

17. The method according to claim 16, wherein the barrier layer serves as an etch stop or hard mask.

18. The method according to claim 16, wherein before and after the step of curing the barrier layer, the barrier layer has a first leakage current and a second leakage current, respectively, and the step of curing the barrier layer is continued until the second leakage current is ½ or less of the first leakage current.

19. The method according to claim 18, wherein the step of curing the barrier layer is continued until the second leakage current is 1/100 or less of the first leakage current.

20. The method according to claim 16, wherein the step of curing the barrier layer is conducted without substantially changing a mechanical strength of the barrier layer prior to the step of curing the barrier layer.

21. The method according to claim 16, wherein the low-k film is constituted by C-doped silicon oxide or N-added, C-doped silicon oxide.

22. The method according to claim 16, wherein the barrier layer is constituted by O-doped silicon carbide or N-doped silicon carbide.
